(19) United States
(12) Patent Application Publication
(10) Pub. No.: US 2021/0197394 A1
(43) Pub. Date: Jul. 1, 2021

(54) BDI SYSTEM FOR THE COOPERATIVE AND CONCURRENT CONTROL OF ROBOTIC DEVICES

(71) Applicant: PONTIFICIA UNIVERSIDAD JAVERIANA, Bogota (CO)

(72) Inventors: Flor Ángela BRAVO SÁNCHEZ, Funza (CO); Alejandra Maria GONZÁLEZ CORREAL, Bogotá (CO); Enrique GONZÁLEZ GUERRERO, Bogotá (CO)

(21) Appl. No.: 17/138,032

(22) Filed: Dec. 30, 2020

(30) Foreign Application Priority Data
Dec. 30, 2019 (CO) NC2019/0015039

(51) Int. Cl. B25J 11/00; G05D 1/02; B25J 9/16

(52) U.S. Cl. CPC B25J 11/003; B25J 9/163; B25J 9/1602; G05D 1/0289

(57) ABSTRACT

The present development relates to a system implementing a multi-agent BDI architecture to control in real time, and in a concurrent and cooperative manner, robotic devices reproducing a series of events defined by a user. The system described herein comprises executing BDI agents in charge of controlling actions executed by robotic devices, a director BDI agent responsible for configuring each executing BDI agent and monitoring the execution of actions, and an interpreting BDI agent through which a user interacts with the system, specifies actions to take and receives status and notifications of progress. Executing BDI agents include a cooperation module with which they communicate with other executing BDI agents, thereby allowing the synchronization of actions. Additionally, each executing BDI agent includes a robot state module with which the emotional expression of the executing BDI agent modulates actions of the robotic device.

### CROSSREFERENCE TO RELATED APPLICATIONS

This application claims priority from Colombian application serial number NC2019/015039 filed on Dec. 30, 2019.

### FIELD OF THE INVENTION

The present development relates to a BDI architecture for the cooperative, concurrent and real-time control of robotic devices.

### BACKGROUND

Development of complex applications in robotics, mobile computing, autonomous control and network management, among others, brings critical requirements that impose special challenges in the design and execution of the system's model. Some of these challenges are performance requirements (including real-time constrains), adaptability and interoperability. These requirements, in turn, demand scalable, modular, flexible and distributed systems which may display emergent properties.

Design of complex systems from requirements can be approached by modeling these systems as autonomous entities (agents) which have mechanisms of communication among them. These structures constitute multi-agent systems (MAS) with important advantages over other approaches to model complex problems due to their dynamic nature, goal orientation, rationality, learning capacity, scalability, modularity and flexibility.

The BDI (belief-desire-intention) architecture is a goal-oriented model that usually employs event-driven execution and presents both deliberative and reactive structures. The BDI agent model is built on a simplified view of human intelligence in which agents have their view of the world (beliefs), certain goals they wish to achieve (desires), and plans (intentions) to act on these desires using their accumulated experience. The structure of beliefs, desires and intentions provides a dynamic way to handle goals of each agent.

Although there are developments related to internal operation of BDI agents, there is a need in the art regarding cooperative, highly concurrent multi-agent architectures, through which complex scenarios such as robotic theater or robotic-theater-based teaching methodologies, interactive entertainment applications, simulation tools to support decision making, among others, can be implemented. Furthermore, there is a need in the art to simply and intuitively define a “script” being interpretable by BDI agents and reproducible with high fidelity by robots.

### BRIEF DESCRIPTION OF THE INVENTION

The present development relates to a system implementing a multi-agent BDI architecture to control in real time, and in a concurrent and cooperative manner, robotic devices reproducing a series of events defined by a user. In the context of this document, “series of events” means any set of activities, actions, feelings and expressions of BDI agents, and relationships between BDI agents developed by following one or more timelines.

The system described herein comprises:
one or more executing BDI agents including registers storing the executing BDI agent's beliefs. Each executing BDI agent further comprises a beliefs manager module controlling the execution state of the graph representing series of events and updating registers storing the state of the robotic device, a BDI engine module controlling agent's desires and intentions, a cooperation module configured to communicate different executing BDI agents with each other so that they can share information on the internal state of each executing BDI agent and to generate interaction signals allowing communication and synchronization between actions executed by different executing BDI agents, an action module that, depending on the executing BDI agent's beliefs, controls actuators of the robotic device by using a function mapping the executing BDI agent's emotional expression in actions that the robotic device can execute through its actuators;
a director BDI agent including registers wherein the graph describing the series of events is stored, an executor configuration module sending control and configuration signals to the one or more executing BDI agents to configure and update their registers, and a third execution manager module of the series of events developed by executing BDI agents; an interpreting BDI agent including an authoring module having a user interface through which system users specify the series of events and control their execution, a translation module translating the series of events to the graph, and a monitoring module of the execution of the series of events.

Additionally, the system disclosed herein comprises one or more communication channels interconnecting executing BDI, director BDI and interpreting BDI agents allowing a concurrent communication between them.

According to the present invention, the graph contains all the information about the series of events (900) defined by the user. Thus, the graph defines actions that executing BDI agents must carry out, the moment they must be executed, their synchronization timing dependencies and synchronization points allowing two or more executing BDI agents to synchronize their execution state. Furthermore, the series of events represented by the graph is executed considering that there may be parallelism between actions executed by different executing BDI agents and/or between different actions executed by the same executing BDI agent.

Agents of the system described herein execute actions following a timeline according to the temporal evolution of the graph. To do this, the beliefs module updates the state of the graph according to the execution status of the series of events and control signals that the director BDI agent sends to the one or more executing BDI agents. Accordingly, execution and direction actions are distributed among different agents acting cooperatively, allowing the synchronized development of the series of events with different degrees of complexity.

### BRIEF DESCRIPTION OF THE DRAWINGS

FIG. 1 shows a general diagram of the system (100) proposed herein wherein executing BDI agents (300), the director BDI agent (400) and the interpreting BDI agent (500) are identified.

FIG. 2 shows an internal diagram of executing BDI agents (300) proposed herein.

FIG. 3 shows an internal diagram of director BDI agents (400) proposed herein.

FIG. 4 shows an internal diagram of interpreting BDI agents (500) proposed herein.

FIG. 5 shows an example of a flow diagram corresponding to the graph (910) wherein action line nodes (DA, UA) and active transition nodes (AT) are differed.

### DETAILED DESCRIPTION OF PREFERRED EMBODIMENTS

The present development provides a system (100) implementing a multi-agent BDI architecture to control robotic devices (200), operating in a work area (700), in a concurrent and cooperative manner. Actions carried out by robotic devices (200) are defined by a user as a series of events (900) specifying activities, actions, feelings and expressions of BDI agents and emotions, as well as individual characteristics and social relationships involving one or more BDI agents. The architecture disclosed herein facilitates the simultaneous execution of cooperative and codependent actions by implementing an agent-based distributed control in which three different types of agents are defined: executing BDI (300), director BDI (400) and interpreting BDI (500), each with its own role within the system. Consequently, it becomes possible to reproduce complex and arbitrary situations where robotic devices (200) can simulate and/or control behavior and interactions between humans and/or different types of autonomous entities.

Within the scope of this document, we will work with three different levels of abstraction related to actions that the system (100) must execute. The highest level is the series of events, which corresponds to the idea that the user has about actions of robotic devices (200). This idea is a concept that can be implemented in many ways. The middle level of abstraction is a computational model in the form of a graph (910) that is obtained by translating the series of events (900) into instructions that can be interpreted by BDI agents. The graph (910) is much more descriptive and detailed, and limits the series of events (900) to those that are possible with the particular architecture being handled. Finally, the lowest level of abstraction corresponds to the signals that executing BDI agents (300) send to robotic devices (200) to activate their actuators (210).

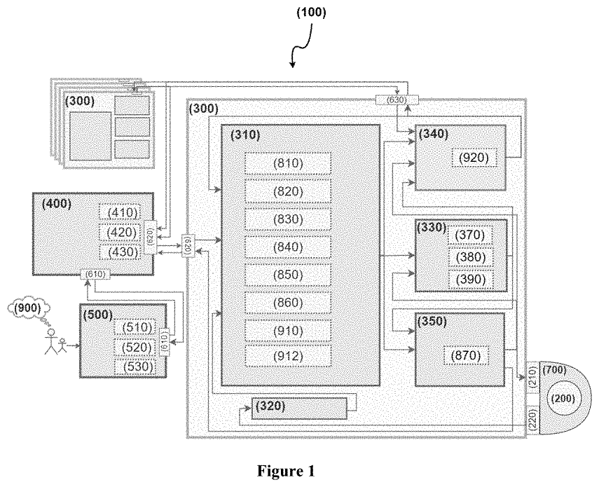

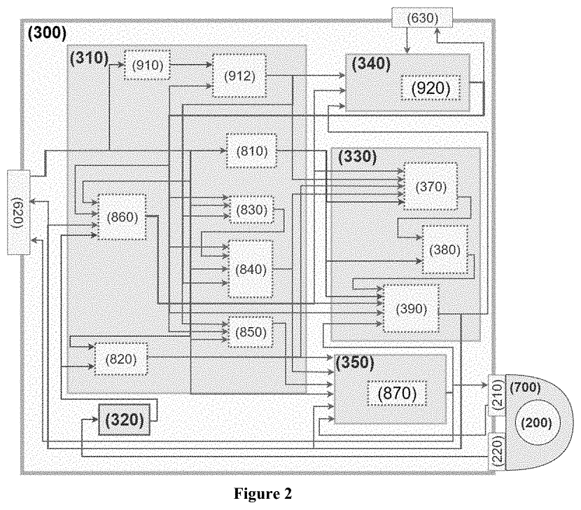

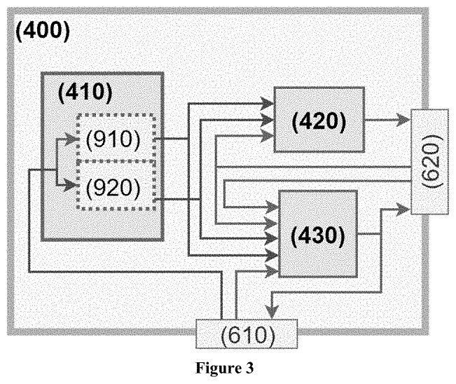

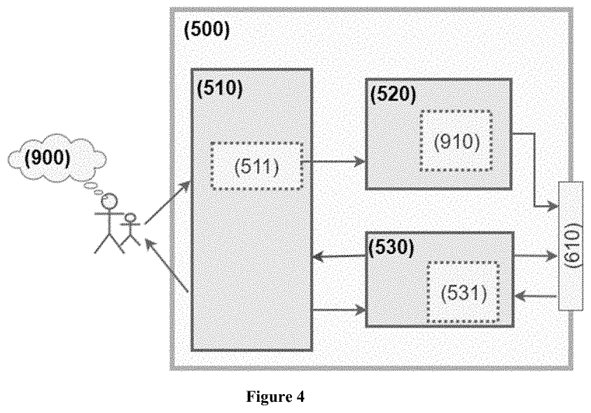

As shown in FIG. 1, the system (100) disclosed herein is characterized in that it comprises one or more executing BDI agents (300) in charge of controlling actions of robotic devices (200) so that it may execute the series of events, a director BDI agent (400) responsible for configuring each executing BDI agent (300) and monitoring the execution of actions they execute, and an interpreting BDI agent (500) through which a user of the system defines the series of events, monitors its status and progress, and sets control instructions. FIGS. 2 to 4 show detailed diagrams of the system (100) wherein each module constituting BDI agents (300, 400, 500), robotic devices (200) and the communication channel (610, 620, 630) are identified.

### Executing Agents

The one or more executing BDI agents (300) include a set of registers in which the beliefs of the executing BDI agent are stored. The beliefs module (310) manages said registers, which include the BDI state (810) representing desires and intentions of each executing BDI agent (300).

According to a preferred embodiment of the invention, the beliefs module (310) of the executing BDI agent further includes the status of the robotic device (820), which includes registers where information, on the performance of actions executed by the robotic device (200), generated by the sensor processor module (320) from the information received by the sensors (220) is stored.

According to a preferred embodiment of the invention, the beliefs module (310) of the executing BDI agent further comprises a social model (830) including the executing BDI agent (300) relationships with other executing BDI agents. The social model (830) is supported by a set of rules regulating the interaction between different executing BDI agents (300).

The beliefs module (310) of the executing BDI agent can also include an emotional model (840) with which actions are modulated and the activation of emergent behaviors executed by the executing BDI agent (300) is controlled. The emotional model (840) modifies the emotional state depending on the emotional information received from other agents and the emotional events associated with actions carried out. The emotional model (840) determines the way in which the emotional state of the executing BDI agent is changed by said external events.

Furthermore, the beliefs module (310) of the executing BDI agent can also include a temperamental model (850) with which the intensity expressed by the emotional state (840) of the executing BDI agent (300) is modulated.

According to preferred embodiments, the beliefs module (310) of executing BDI agents (300) further comprise a world model (860) including a list with positions of each robotic device (200) or other objects in the work area or physical environment (700) wherein activities of the system are carried out (100), a list with movement intentions of robotic devices (200), and a map containing positions available in the work area and possible trajectories between them. The map allows each executing BDI agent (300) to plan the path that the corresponding robotic device (200) will follow to move through the work area, so that robotic devices (200) associated with two or more executing BDI agents (300) do not accidentally collide, with each other or with other objects present in the work area (700). The list of intentions allows planning the movement of robotic devices (200) associated with each executing BDI agent (300) so that they collaborate and coordinate with each other to avoid collisions.

According to the present invention, registers (310) also store a graph (910) of the series of events (900) defining actions that the executing BDI agent (300) must execute, the moment they must be executed, their synchronization timing dependencies and synchronization points allowing two or more executing BDI agents (300) to synchronize their execution state. Graph (910) is a representation of the series of events (900) wherein instructions of each module of the system (100) are specified. Graph (910) is executed considering that there may or may not be parallelism between actions executed by different executing BDI agents (300) or between different actions executed by the same executing BDI agent (300). Given that each executing BDI agent (300) has its own registers (310) wherein graph (910) and its execution status (912) are stored, there are multiple instances thereof distributed throughout the system (100). Therefore, it is necessary to keep the information on the execution status of the graph (912) synchronized between different BDI agents of the system (100).

According to a preferred embodiment of the invention, the graph (910) is implemented through an extension of Petri Nets with Active Transitions. Petri Nets facilitate the specification and simultaneous and parallel execution of actions of the series of events (900), which correspond to instructions that robotic devices (200) must execute. Accordingly, Petri Nets allow robotic devices (200) to execute different actions in a concurrent and synchronized manner.

In the model of Petri Nets with Active Transitions disclosed herein, actions of the series of events (900) can be of two types: the so-called defined duration actions (DA), which autonomously end their execution as a consequence of an event detected by robotic device sensors or actuators (200); and the so-called undefined duration actions (UA), which completion is activated by an event, associated with the completion or activation of another independent action, either in the same agent or in an external agent. Additionally, the activation of actions may depend on the completion of the execution of another action, either by another external agent, or by the same executing BDI agent (300).

On the other hand, Active Transitions extend the traditional Petri Nets model to incorporate proactive behaviors. In fact, besides allowing the traditional management of synchronization of actions, Active Transitions also take a proactive role to influence the completion of actions of undefined duration or the activation of actions in a expropriate manner.

This model of Petri Nets with Active Transitions has the following characteristics:
Synchronization of actions of the same executing BDI agent (300):
   a) Synchronization of sequential actions: a sequential action must wait for the completion of the one preceding it on the network. Since they are actions carried out by the same executing BDI agent (300), the synchronization can be carried out directly through sequential invocations of actions.
   b) Synchronization of parallel actions: an agent can execute multiple actions simultaneously. In this case, if actions are of defined duration and need to be synchronized, they must be connected to an active transition which will enable the execution of one or more subsequent actions once all actions entering the active transition have completed their execution.
Synchronization of different executing BDI agents (300). This synchronization is achieved through the cooperation of executing BDI agents (300):
   a) Synchronization of sequential actions: each executing agent must wait for other executing BDI agents (300) to report the completion of the execution of their actions. Once all actions entering the active transition have been completed, the transition will enable the execution of subsequent actions.
   b) Synchronization of parallel actions: different executing BDI agents (300) can execute actions simultaneously. When these agents have reported the completion of their actions, the associated active transition will enable the execution of subsequent actions.
Manage the completion of undefined duration actions (UA). There are two mechanisms for completing actions of undefined duration (UA):
Undefined duration actions (UA) end when all other simultaneous actions of defined duration (DA), connected to the same active transition, have completed their execution.
   a) Expropriation: the active transition has control over undefined duration actions (UA) on which it depends, and can end an action that has not been yet completed. To this end, actions subsequent to the active transition can verify if their activation conditions are met, in which case the expropriation mechanism of the active transition is activated.

As mentioned above, according to an embodiment of the invention, in the model of Petri Nets with Active Transitions used, actions can be of two types: defined duration actions (DA), which end their execution autonomously as consequence of an event detected by sensors or actuators; and undefined duration actions (UA), which completion is generated by an event associated with another action. Additionally, the activation of actions may depend on the completion of the execution of another action, either from the same executing BDI agent (300) or from another.

Thus, according to a preferred embodiment of the invention, the graph (910) is implemented through an extension of Petri Nets with Active Transitions. This graph is characterized by having two types of nodes: action line nodes (DA, UA) and active transition nodes (AT). Action line nodes (DA, UA) begin and end at active transition nodes (AT). Each action line nodes (DA, UA) have an associated action from the series of events (900), and corresponds to an instruction that a robotic device (200) must execute. The active transition nodes (AT) are used to synchronize actions in the series of events (900). This type of node has two main purposes: first, to synchronize actions that a single robotic device (200) must carry out. For example, a robotic device can fly over a field while taking pictures and releasing marking marks at specific locations, all at the same time. The second purpose of the active transition nodes (AT) is to synchronize actions executed by two or more robotic devices (200). For example, two robotic devices synchronize their actions to build a brick wall. The first robotic device is responsible for spreading the cement and the second device is responsible for placing the bricks. When the first robotic device finishes its task, it informs the second robotic device to place the bricks. When the second robotic device finishes placing the bricks, it informs the other device to spread another layer of cement.

Action line nodes (DA, UA), which determine actions to be executed, have two types of duration: defined and undefined. Action line nodes (AD) of defined duration are associated with actions that run during a limited, predictable time interval. On the other hand, action line nodes (UA) of undefined duration are those which execution is carried out continuously and their completion depends on independent events associated with nodes of other action lines and over which they have no control. The implementation of active transition nodes (AT) responds to the need to coordinate actions even when the duration of the same is unknown. To do this, each Active Transition node (AT) must wait for all actions corresponding to Action Line nodes (AL) connected thereof to have completed. In this way, active transition nodes (AT) act as temporary coupling points that do not allow an action line to continue executing until all actions on which the active transition node (AT) depends have been completed. Only when all action line nodes (DA, UA) going towards an active transitions node (AT) have completed their execution, subsequent action line nodes (DA, UA) can begin. Accordingly, different executing BDI agents are brought to act in a cooperative and synchronized manner.

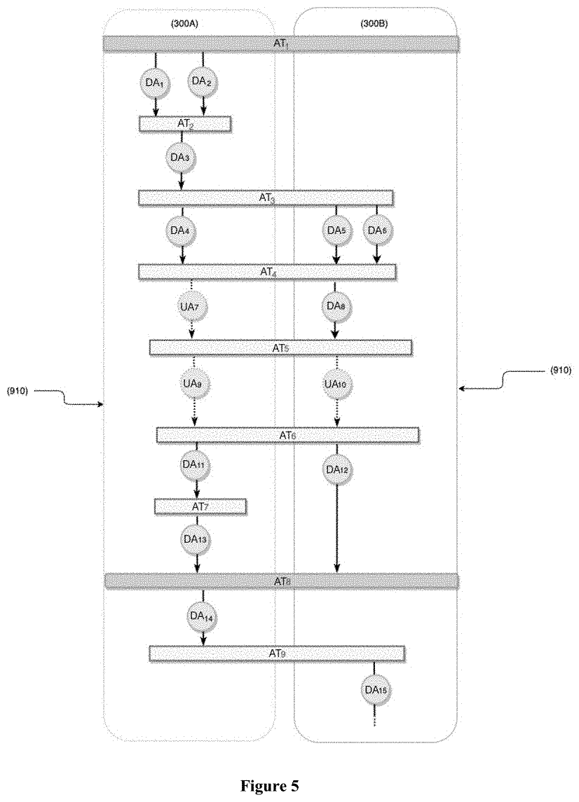

FIG. 5 shows an example of a graph (910) implemented through a Petri Net with Active Transitions for the system (100) described herein. This example shows how Petri Nets with Active Transitions allow cooperation between agents in order to enable synchronization of actions. Action line nodes (DA, UA) represent actions executed by two BDI agents (300A) (300B), while active transition nodes (AT) represent active transitions. Solid lines (DA) represent defined duration actions and dotted lines (UA) represent undefined duration actions. In FIG. 5, the transition AT₂ will only activate after actions DA₁ and DA₂ have completed; at this moment, the execution of action DA₃ will begin which, upon completion, will activate transition AT₃, thereby simultaneously starting actions DA₄, DA₅ and DA₆. Transition AT₄ begins actions UA7, of undefined duration, and DA₈, of defined duration. Action UA₇ will be executed until the active transition AT₅ orders its completion as the execution of the action of defined duration DA₈ was completed or because subsequent actions UA₉ and UA₁₀ meet their activation conditions.

As shown in FIG. 5, the combination of action line nodes (DA, UA) and active transition nodes (AT) allows actions to be executed in a concurrent and synchronized manner. The execution of the series of events (900) is a sequence of actions distributed among different executing BDI agents (300) which temporary synchronism and coordination is due to the interaction between these two types of nodes.

The one or more executing BDI agents (300) further include a sensor processor module (320) that, based on the sensory information received by the robotic device (200) through its sensors (220), performs processing allowing generating useful information to update the world model (860) and the robotic device status (820).

The development disclosed herein has as an essential characteristic that each executing BDI agent (300) further includes a cooperation module (340) configured to communicate different executing BDI agents (300) with each other. The information that an executing BDI agent (300) receives from other executing BDI agents (300) allows it to update its beliefs (310); in particular, the social (830), emotional (840) and temperamental (850) model. The cooperation module (340), by means of graph's execution coordination function (920), updates the execution status of the graph (912) and manages the activation of active transitions (AT) of the graph (910). Accordingly, the synchronization of the execution status (912) of different instances of the graph (910) stored in registers (310) of each executing BDI agents (300) of the system (100) is achieved.

The cooperation module (340) is also configured to generate interaction signals, which allow the synchronization of actions executed by different executing BDI agents (300). These interaction signals communicate to other executing BDI agents (300) that an active transition node (AT) of the graph (910) has been activated, allowing the start of the distributed, concurrent and parallel execution of actions of the series of events (900). Similarly, when an event affecting the execution status occurs, such as the completion of the execution of an action, all executing agents (300) send signals to the others, allowing thus control of synchronizations carried out in active transition nodes TA of the graph (910).

An object of the invention described herein is controlling robotic devices by implementing a BDI architecture. Accordingly, the state of robotic devices (820) is defined as the set of variables that fully define the instantaneous characteristics of the robotic device (200). These characteristics include static parameters, such as physical or structural configuration of the robotic device (200), actions that this robotic device can carry out, and specification of parameters of actions that can be manipulated. Also included are dynamic variables such as their battery level, position, speed, or their actuators status. Each robotic device (200) can have one or more actuators (210) which include engines, audiovisual devices, display devices, speakers, lights, and means of locomotion, among others. Within the context of this invention, actuators are not limited to discrete actuation elements, but can also be robotic subsystems with specific functionalities. For example, each robotic device (200) can be composed by complex modules. Likewise, preferred embodiments of the invention are characterized in that robotic devices (200) further comprise sensors (220) which information is received by the sensor processor module (320) which updates the world model (860) and the status of the robotic device (820) of the executing BDI agent (300).

According to a preferred embodiment, each executing BDI agent (300) has one and only one robotic device (200) associated, so that all actions of each robotic device (200) are controlled by a single executing BDI agent (300). Thus, each executing BDI agent (300) is in charge of generating behaviors that the robotic device (200) must execute to carry out the series of events (900) represented in the graph (910). For this purpose, each executing BDI agent (300) further comprises an action module (350) of the executing agent. The action module (350) is further configured to control in a concurrent manner and in real time the one or more actuators (210) of the robotic device (200).

Action module (350), with which the robotic device (200) is controlled, supports its operation on the status information of the robotic device (820) and on the function of the mapping model of actions and emotions (870). This function calculates, taking into account emotional and temperamental states, the configuration and parameters of actions to be executed by the robotic device (200) through its actuators (210).

In a first case, the function (870) is a relationship between actions specified in the graph (910) and signals at robot level to activate actuators (210). For example, if the graph (910) defines the action “walk forward”, the function (870) could translate this instruction into the following commands for the robot: engine power: 30%; wheel angle: 0°. Instead, the function (870) would translate the “run in circles” action into the following commands for the robot: engine power: 80%; wheel angle 110°. Accordingly, the function (870) maps actions defined in the graph (910) in specific commands that have a direct impact on the operation of actuators (210).

In a second case, complementary to the first case, the function (870) modulates the intensity of actions executed by the robotic device (200) depending on the emotional state and the parameterization of the executing BDI agent (300). For example, if the graph (910) defines the action “walk forward” for a sad BDI agent, the function (870) could translate this instruction into the following commands for the robot: engine power: 10%; wheel angle: 0°. Instead, the function (870) would translate the same action defined for a happy BDI agent as: engine power: 45%; wheel angle 0°. Accordingly, the robotic device (200) can express the emotional state of the executing BDI agent (300).

The one or more executing BDI agents (300) are characterized in that they further comprise a BDI engine module (330) implementing deliberation mechanisms for goal management and selection of intentions determining actions that the robotic device (200) must carry out. This BDI engine module includes three internal modules: goal analysis (370), deliberation (380) and means-end reasoning (390).

### Director Agent

According to the present invention, the system (100) further comprises a director BDI agent (400) responsible for configuring each executing BDI agent (300) and for controlling and monitoring the execution of the series of events (900). The real-time synchronization of actions is the responsibility of executing BDI agents (300) as they implement coordination mechanisms through the cooperation module (340) for this purpose.

The director BDI agent (400) includes a descripting module containing one or more registers (410) where an additional instance of the graph (910) of the series of events (900) and the execution status (920) of the series of events (900) are stored. The execution status (920) contains information on the execution status of the series of events (900); that is, its execution to be activated, paused, restarted or stopped. The execution status (920) further contains information on which point of synchronization of the graph (910) at which the one or more executing BDI agents (300) should start the execution of the graph (910).

The director BDI agent (400) additionally comprises an executor configuration module (420) and a third execution manager module (430). The executor configuration module (420) uses the graph (910) to configure and update the beliefs (310) of the one or more executor BDI agents (300). The execution manager module (430) uses the execution status model (920) to send the one or more executing BDI agents (300) activation signals of the graph (910). These activation signals indicate executing BDI agents at which point of synchronization of the graph (910) they should start the execution. Activation signals can also indicate whether to pause, restart or stop the execution of the series of events (900).

The executor configuration module (420) is designed to send control and configuration information to the one or more executing BDI agents (300) to configure and update their beliefs (310) based on the information stored in the one or more registers (410) of the director BDI agent (400). The execution status of the graph (912) of executing BDI agents (300) is updated according to the activation signals send by the director BDI agent (400). According to preferred embodiments of the invention, the configuration information that the director BDI agent (400) communicates to each executing BDI agent (300) can be classified into four groups: event description, agent description, environment description and robots description.

The description of events corresponds to the entire graph (910). The director BDI agent (400) distributes copies of the graph (910) so that each executing BDI agent (300) has information on actions that must be executed, who must execute them and when. Since the director BDI agent (400) sends the same graph (910) to all executing BDI agents (300), this configuration is what allows the subsequent synchronization of events.

The description of agents corresponds to the emotional, temperamental, social characteristics of executing BDI agents (300), as well as the configuration of BDI status (810) thereof. Through this configuration, the director BDI agent (400) defines differences and characteristics of each of different executing BDI agents (400).

The environment description is the information on the physical environment or work area (700) in which actions of the series of events (900) will take place. This includes information on topology, surfaces, obstacles, reference points, environmental conditions, among others. From this information, the one or more executing agents (300) carry out the parameterization and initialization of the world model (860).

Finally, the description of robots corresponds to the characteristics of robotic devices (200) associated with each executing BDI agent (300). This configuration corresponds to static parameters of the state of the robotic device (820) that each executing BDI agent (300) stores in registers of the beliefs module (310).

The execution manager module (430) uses the execution state (920) to send the one or more executing BDI agents (300) activation signals indicating the execution state of the graph (910), that is, whether it is active, paused, stopped, or about to restart. Executing BDI agents (300) are also inform at which point of synchronization the execution of the graph (910) should begin. This agent sends signals to executing agents (300) to implement high-level execution control instructions provided by the user through the interpreting agent (500). Similarly, the execution manager module (430) monitors the synchronization signals exchanged by executing agents (300), registers them and forwards them to the interpreting agent (500). The execution manager module (430) operates as a bridge between the interpreting agent (500) and the one or more executing agents (300).

### Interpreting Agent

According to the present development, the system (100) disclosed herein further comprises an interpreting BDI agent (500) through which a user can interact with the system (100), define the series of events (900), control it in an asynchronous manner and receive information in real-time on their execution. According to a preferred embodiment, the interaction between the user and the interpreting BDI agent (500) is intuitively conducted by using natural language, whereby the user does not need specific technical knowledge. The interpreting BDI agent (500) comprises an authoring module (510) that has a user interface (511) through which the user of the system (100) specifies the series of events (900). The series of events (900) corresponds to an abstract and high-level description that fully specifies the behavior of robotic devices (200), and actions they must carry out and the synchronization thereof. In a specific application of the present development, the series of events (900) can be understood as a script that robotic devices (200) follow.

In accordance with embodiments of the invention, the user interface (511) may be a graphic interface and/or an interface implementing a demo learning method or other specifying method of the series of events. Within the context of this development, the demo learning method consists of the user specifying actions that executing BDI agents (300) execute through direct interaction with robotic devices (200) associated with each executing BDI agent (300). For example, the user takes the robotic device (200) and moves it along a path which is incorporated into the graph (910).

Since the user defines the series of events (900) as a conceptual description of actions that the system must carry out, it is necessary to convert this description into an element that can be executed by BDI agents of the system. For this, the interpreting BDI agent (500) further includes a translation module (520) that translates the series of events (900) to the graph (910) which can be interpreted by other BDI agents of the system (100). Graph (910) generated by the interpreting BDI agent (500) is sent to the director BDI agent (400), so that it can distributed to executing BDI agents (300), together with control and configuration signals.

According to preferred embodiments, the interpreting BDI agent (500) further comprises a monitoring module (530) including a register (531) wherein the global state of the system (100) is stored. Said monitoring module (530) is configured for the user to send, during execution, activation signals to the director BDI agent (400) that alter the execution of the series of events (900). This asynchronous sending of activation signals gives the user full control over the execution of the series of events (900) even after it has started; through the monitoring module (530) the user can thus stop, restart, pause and resume the execution of the system (100). Additionally, the monitoring module (530) is configured so that the user receives through the graphic user interface (511) information on the beliefs of executing BDI agents (300); in particular the state of robotic devices (820) and the execution state of the graph (920) of the series of events (900).

### Communications Channel

The system (100) according to the present invention further comprises a communication channel (600) that interconnects BDI agents (300, 400, 500) allowing a concurrent communication between them. According to preferred embodiments of the invention, the system (100) comprises dedicated communication channels between different types of BDI agents. The system (100) may include a coordination channel (610) that corresponds to a dedicated communication channel between the interpreting BDI agent (500) and the director BDI agent (400); a configuration and monitoring channel (620) corresponding to a dedicated communication channel between the director BDI agent (400) and each executing BDI agent (300); a cooperation channel (630) corresponding to a dedicated communication channel between executing BDI agents (300).

In one aspect of the present invention there is considered that the user of the system (100) can define alternative series of events to be executed by robotic devices (200). The decision of which series of events (900) should be executed is entered by the user at runtime through the interpreting BDI agent (500) or deduced from the sensory information received by one or more executing agents. In accordance with embodiments of the invention where this is the case, the series of events (900) will be recursively constructed from the various series of events defined by the user. The possible sequence relationships between the series are modeled by decision nodes. In this case, the interpreting BDI agent (500) will generate an independent graph (910) for each of the series of events constituting the series of events (900). Additionally, the director BDI agent (400) is configured to inform the one or more executing BDI agents (300) which graph (910) must be executed depending on the series of events (900) chosen by the user.

### BDI Engine

In preferred embodiments, BDI agents have those characteristics disclosed in WO2019/064287, which application is incorporated herein by reference in its entirety.

The BDI engine module (330) is in charge of managing agent's goals to decide which ones become intensions; actions that an executing agent (300) must execute are associated with plans allowing goals been activated as intentions to be met. According to a preferred embodiment, the BDI engine module (330) relies on the information recorded in the beliefs module (310) and consists of three internal modules: goal analysis (370), deliberation (380) and management of means and ends (390).

According to a preferred embodiment, executing BDI agents (300) comprise a goal analysis module (370) managing the evolution of desires of executing BDI agents (300) into intentions. Goal analysis module (370) includes a set of finite state machines parallelly operating, and concurrently evaluating activation of potential goals. The output of this set of finite state machines updates the BDI state (810) of executing BDI agents in real time.

Executing BDI agents (300) can also include a deliberation module (380) which prioritizes intentions of each executing BDI agent (300) in real time. The deliberation module (380) includes a set of finite state machines parallelly operating, and implementing a mediation mechanism to prioritize potential goals activated by the goal analysis module (370). Under circumstances, an executing BDI agent can have multiple mutually-exclusive active goals and must decide therefore which one to perform first. The deliberation module (380) implements a prioritization paradigm including a hierarchical model to determine the relevance of different intentions of the executing BDI agent (300) and organize them accordingly. In general, this hierarchical model includes at least two priority levels wherein different goals, possible intentions, are classified taking into account their contribution to general goals of the agent. According to one embodiment of the present invention, the hierarchical model considers six goals categories: attention, requirements, needs, opportunities, obligations and survival actions.

On the other hand, and according to other embodiments of the present development, executing BDI agents (300) comprise a means-ends management module (390) which controls actions of the executing BDI agent (300) depending on their desires and intentions. The means-ends management module (390) execute intentions of the executing BDI agent (300) and sends signals to the action module (350) to control actuators (210) of the robotic device in a concurrent manner and in real time. Accordingly, desires and intentions of the executing BDI agent (300) become actions materialized by actuators (210) of robotic devices (200).

Furthermore, as a result of the operation of BDI engine modules (330), executing agents (300) are also configured to carry out emergent actions in an improvised manner; that is, they are not explicitly included in the graph (910) or in the series of events (900). These agents can manage improvisation goals activated in an emergent manner by internal or external events detectable or generated by the environment or other agents. For example, these activation events can be generated by internal events related to the emotional state of the agent or the battery level of the robotic device; these events can also be produced by other executing BDI agents (300) (such as the failure of a robot blocking a path), human actors (interactions with the audience) or disturbances in the environment (falling of an object in the work area preventing the performance of an action), and even reactions to emotional events may be generated (such as the performance of actions related to empathy between executing agents). Through these emergent behaviors, the executing BDI agent (300) can react by adjusting its behavior temporarily and then continue with the execution of the series of events (900).

The present invention further contemplates a method of controlling robotic devices (200) employing the architecture described herein. The method consists of defining a series of events (900) that must be executed by robotic devices (200) and introducing said series of events (900) in an interpretation module (500); translating the series of events (900) into a graph (910) defining actions to be executed by different executing BDI agents (300) associated with robotic devices (200); sending the graph (910) to each of executing BDI agents (300) and updating their BDI status (810) together with the status of the graph (910) as the execution of the series of events (900) progresses. The updating of beliefs of each executing BDI device is characterized in that it depends on beliefs of all executing BDI agents, as well as the state of robotic devices (200) and the temporal evolution of the graph (920). Since each BDI agent is independent, the method described herein allows the concurrent, cooperative and synchronized execution of the series of events, regardless of their complexity.

### Example 1

A first non-limiting application of the present invention is the robotic drama, which consists of the representation of a theater play in which actors are robots. Within the scope of this development, the tale or story that the author of the play desires to represent corresponds to the series of events, the script of the theater play corresponds to the graph (910) describing each of actions that actors must carry out, each character is associated with an executing BDI agent (300), and the stage in which the play takes place is the work area (700). Robot actors must follow the script, move around the stage, interact with each other and, if necessary, improvise actions.

In the case of robotic drama, robots can be anthropomorphic, zoomorphic, or otherwise. Actuators usually move parts that resemble arms, legs and fingers, although it is also very common for the main locomotion mechanism to be wheels. Actor robots may also have a display device that also works as a face, on which images are projected helping represent the actor's emotional state. In general, in order to fully use the potentialities of the system (100) according to the invention, it is preferred that the actor robot be modular with different possible configurations and with the ability to express emotions.

The creation and execution of a theater play for robotic drama could be done as follows: first, the author defines the story (series of events (900)) desired to be represented. This story can be described in general and colloquial terms, and does not require the author to handle any type of technical language. For example, the author may be a child and the story may be a fragment of the Red Riding Hood story.

Once the author has defined the story, it uses a user interface to enter it into the system. This user interface corresponds to the interface (511) that is part of the authoring module (510) of the interpreting BDI agent (500). The story is then translated and converted into the script of the play (graph (910)).

The script includes all the information necessary for the theater play to be carried out: the characters involved (executing BDI agents (300)), their movement and lines of dialogue, their behavior, reactions and relationships with other characters (emotional (840), temperamental (850) and social (830) models), the characteristics of the setting and the scenography (work area (700)), the physical characteristics of the actors (robotic devices (200)) that each character will represent, and the signals and coordination points between actors. Table 1 shows an example of a story and the corresponding script.

Comparison between series of events (900) and script (910) according to
the present invention.

| STORY | SCRIPT |
|---|---|
| series of events (900) | graph (910) |
| Little Red Riding Hood is | Characters: Little Red Riding Hood, Mother, |
| a girl who lives in the | Storyteller |
| forest with her mother. | SCENE 1 |
| One day, her mother asks | It takes place inside Little Red Riding Hood's |
| her to take a basket of | house. Little Red Riding Hood’s mother is |
| cookies to her sick | sitting in an armchair, knitting. Little Red |
| grandmother who lives on | Riding Hood and her mother have a close and |
| the other side of the forest. | loving relationship. |
| Little Red Riding Hood | Storyteller: Once upon a time there was a girl |
| takes the cookies and | named Red Riding Hood who lived in the |
| leaves her house towards | forest with her mother. |
| her grandmother's | (Little red riding hood enters, singing) |
| | Little Red Riding Hood (Happy): What a |
| | beautiful day! |
| | Mother (Calm): Hello Little Red Riding Hood. |
| | I have an important job for you. Take that |
| | basket of cookies to your grandmother. She is |
| | ill and the cookies will make her feel better. |
| | (The mother points to a basket on the table. |
| | Little Red Riding Hood approaches the table |
| | and takes the basket) |
| | Little Red Riding Hood (Excited): Of course! |
| | I will love visiting grandma! |
| | (Little Red Riding Hood jumps out of the |
| | house and her mother stays sitting on the |
| | couch, knitting) |

As Table 1 shows, the story is general and conceptual, and does not require specificity of details from the author. Instead, the script is a much more descriptive version and defines specific actions, relationships between characters, emotions, and temporal relationships between actions to be executed.

Although the script defines what each actor should do, and how and when they should do it, the performance of a theater play requires cooperation between different actors. At this point, the cooperation module (340) of executing BDI agents (300) comes to play an important role, which guarantees integral communication between actors so that all the relevant information of characters is known by others.

After each robot actor has the script, it must start with its performance, that is, represent the script through the appropriate actions. For this, the BDI engine module (330) manages goals directly related to actions of the script, but also goals associated with emergent improvisational behaviors. The action module (350), relying on the mapping function of actions and emotions (870), translates each action into signals enabling the operation of actuators. In the example shown in Table 1, Little Red Riding Hood's expression is different from her mother's. While Little Red Riding Hood talks happily and excited, her mother is calm. This difference, specified in the script and which must be transmitted by the robotic actors, is achieved through the function (870). For example, the volume of Little Red Riding Hood's voice may be louder than her mother's, indicating that she is more excited. Function (870) can also relate Little Red Riding Hood's joy to a more accelerated and emphatic movement of her limbs, while her mother, who weaves calmly, has more subtle movements. Also, if robot actors for Little Red Riding Hood and her mother include display devices, they could show a pair of big, bright eyes for Little Red Riding Hood and calm ones for her mother.

Mapping emotions of the character in actions of the actor is particularly useful in robotic drama as it is what allows actions of the robot to resemble the expected behavior of the character through intonation in dialogues, sounds, gestures, pauses when speaking, speed of movements and facial expression displayed.

Concurrently, if an executing BDI agent has a happiness emergent action that is activated when its happiness intensity level reaches a certain level (for example, 80% of the maximum intensity), when the activation condition of the emergent behavior, the executing BDI agent will execute actions that were associated with this behavior; for example, saying “hooray!” while jumping.

Now, in the case in which this executing BDI agent is executing the script action “walk” and an emotional event occurs making its level of happiness to increase and reach the level required to activate the emergent behavior of happiness (that is, the intensity level exceeded 80% of the maximum intensity), since the emergent behavior of happiness has a higher priority than the walking action in the script, an expropriation of the walk action is carried out to execute actions of the emergent behavior. That is, the executing BDI agent will pause the execution of the walk action and will execute actions: say “hooray!” and jump. When the executing BDI agent completes emergent behavior actions, the execution of the action that was expropriated or another action of higher priority that may have arisen will resume.

Script execution may be subject to unforeseen and uncontrolled conditions. For example, an actor may fall or stage conditions may change. In addition, part of the story may include interaction with humans or animals. In these circumstances, robotic actors must be able to react to non-predefined events and behaviors. Here, the emotional model (810) of each character allows the development of emergent behaviors, which are improvisational mechanisms with which the actor can respond to unknown circumstances and seek to continue in the script.

The user interface also allows the author of the play to control its execution. This can pause, rewind, fast-forward, accelerate or finish the execution of the play through options in the graphic interface. Through this means, the author can also learn information about the status of each actor, the characteristics of the characters and the general development of the script.

Additionally, executing BDI agents have low priority goals allowing executing BDI agents not to freeze when they have no action to take. For example, a goal may be to show that the robotic device is observing others with whom it is interacting. Another low priority goal may be for the device to have small movements in its body such as moving its arms or head.

What is claimed is:

1. A system implementing a concurrent multi-agent BDI architecture to control robotic devices in real time reproducing a series of events defined by a user, the system comprising:
one or more executing BDI agents including:
a beliefs module including one or more registers storing:
a computational model in the form of a graph representing the series of events and the execution status of the graph;
the BDI state representing the agent's desires and intentions;
the status of the robotic device, which stores information on actions carried out by the robotic device;
a world model including the positions of robotic devices or other objects and a map of the work area;
a sensor processor module that from the sensory information allows generating information to update the world model and the state of the robotic device;
a BDI engine module in charge of managing agent's goals to decide which ones become intensions; actions that an executing agent must execute are associated with plans allowing goals been activated as intentions to be met.
a cooperation module configured to communicate different executing BDI agents with each other, allowing to update their beliefs, coordinate the execution of the graph, update the execution state of the graph, and generate interaction signals for synchronization with other executing agents;
an action module, depending on the beliefs of the executing BDI agent, concurrently and in real time controls one or more actuators of the robotic device; and supports its operation in the function of the mapping model of actions and emotions;
a principal BDI agent including:
a descripting module containing one or more registers storing:
an additional instance of the graph of the series of events;
a model of the execution state of the series of events;
an executor configuration module sending control and configuration signals to the one or more executing BDI agents to configure and update their registers based on the state of the graph stored in the one or more registers;
an execution manager module sending to the one or more executing BDI agents activation signals indicating which is the execution status of the graph, that is, if it is paused, stopped or about to restart;
an interpreting BDI agent including:
an authoring module having a user interface wherein a user of the system specifies the series of events;
a translation module translating the series of events to the graph which can be interpreted by other BDI agents of the system;
a set of communication channels interconnecting BDI agents allowing there to be concurrent communication between them;
wherein:
the graph defines actions that the executing BDI agent must execute, the moment they must be executed, their synchronization timing dependencies and synchronization points allowing two or more executing BDI agents to synchronize their execution state;
the series of events represented by the graph is executed considering that there may be parallelism between actions executed by different executing BDI agents or between different actions executed by the same executing BDI agent;
the beliefs are updated, including the execution status of the graph according to the information received from other executing agents processed by the cooperation module and the activation signals that the director BDI agent sends to the one or more executing BDI agents.

2. The system according to claim 1, wherein each executing BDI agent has associated one and only one robotic device.

3. The system according to claim 1, wherein the user interface is selected from the group comprising: a graphic interface and/or an interface implementing a demo learning method or other specifying method of the series of events.

4. The system according to claim 1, wherein the executing BDI agent beliefs module further comprises:
a social model including the executing BDI agent relationships with other executing BDI agents; the social model is supported by a set of rules regulating the interaction between different executing BDI agents;
an emotional model with which actions are modulated, and activation of emergent behaviors executed by the executing BDI agent is controlled; the emotional model modifies the emotional state depending on the emotional information received from other agents and emotional events associated with actions carried out; and
a temperamental model with which the intensity expressed by the emotional state of the executing BDI agent is modulated.

5. The system according to claim 1, wherein the one or more executing BDI agents are characterized in that they further include, in the BDI engine module, a goal analysis module including a set of finite state machines parallelly operating, and concurrently evaluating activation of potential goals, wherein the output of the set of finite state machines updates in real time the BDI state of the one or more executing agents.

6. The system according to claim 1, wherein the one or more executing BDI agents are characterized in that they further include, in the BDI engine module, a deliberation module including a set of finite state machines parallelly operating, and implementing a mediation mechanism to prioritize goals activated by the goal analysis module.

7. The system according to claim 1, wherein the one or more executing BDI agents are characterized in that they further include, in the BDI engine module, a means-ends reasoning module which executes intentions of the executing BDI agent and sends signals to the action module to control in a concurrent manner and in real time one or more actuators of the robotic device corresponding to the intention executed.

8. The system according to claim 1, wherein the beliefs module has bidirectional communication with the cooperation module so that each executing BDI agent can update its registers based on the state of the beliefs module of other executing BDI agents.

9. The system according to claim 1, wherein the graph is an extension of Petri Nets with Active Transitions.

10. The system according to claim 1, wherein the graph is characterized by having action line nodes (DA, UA) and active transition nodes (AT).

11. The system according to claim 1, wherein robotic devices further comprise sensors with which the beliefs of the executing BDI agent are updated; in particular, the world model and the state of the robotic device.

12. The system according to claim 1, characterized in that it further comprises a coordination channel corresponding to a dedicated communication channel between the interpreting BDI agent and the director BDI agent.

13. The system according to claim 1, characterized in that it further comprises a configuration and monitoring channel corresponding to a dedicated communication channel between the director BDI agent and each executing BDI agent.

14. The system according to claim 1, characterized in that it further comprises a cooperation channel corresponding to a dedicated communication channel between executing BDI agents.

15. The system according to claim 1, characterized in that the interpreting BDI agent wherein the monitoring module:
further includes a register wherein the global state of the system is stored;
configured so that the user sends instructions to the director BDI agent during execution that alter the execution of the series of events;
configured so that the user receives through the user interface information on the beliefs of executing BDI agents, the state of robotic devices and the execution state of the graph of the series of events.

16. The system according to claim 1, wherein the monitoring module is further configured so that the user can stop, restart, pause and resume the execution of the system.

17. The system according to claim 1, wherein the beliefs of each executing BDI agent further comprise a world model including:
a list of positions in the work area that are occupied by other robotic devices or other objects;
a list with movement intentions of robotic devices used to prevent more than one occupying the same work area position; and
a map containing available positions in the work area and possible paths between them;
wherein:
the information from the world model allows each executing BDI agent to independently plan the path that the corresponding robotic device is going to follow to move through the work area, so that robotic devices associated with two or more executing BDI agents collaborate with each other, and accidental collisions are avoided.

18. The system according to claim 1, characterized in that:
the series of events may consist of more than one user-defined series of events;
the interpreting BDI agent is configured to generate an independent graph for each of the series of events constituting the series of events; and
the director BDI agent is configured to inform the one or more executing BDI agents which graph must be executed.
